(19) United States
(12) Patent Application Publication
(10) Pub. No.: US 2007/0159058 A1
(43) Pub. Date: Jul. 12, 2007

(54) PHOSPHORS AND DISPLAY DEVICE

(75) Inventors: Iwao Mitsuishi, Tokyo (JP); Hironori Asai, Yokohama-shi (JP); Nobuyuki Yokosawa, Fukaya-shi (JP); Masaaki Inamura, Fukaya-shi (JP); Yoshitaka Funayama, Fukaya-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/610,011

(22) Filed: Dec. 13, 2006

(30) Foreign Application Priority Data
Dec. 28, 2005 (JP) P2005-380276

(51) Int. Cl. H01J 63/04; H01J 1/62

(52) U.S. Cl. 313/496; 313/495; 313/503; 313/497

(57) ABSTRACT

A phosphor particle includes a phosphor containing zinc sulfide as a base material, and a coating layer applied on the phosphor and made of a magnesium phosphate expressed by Mg₃(PO₄)₂.

### CROSS REFERENCE TO RELATED APPLICATIONS

This application is based upon and claims the benefit of priority from the prior Japanese Patent Application No. 2005-380276 filed on Dec. 28, 2005, the entire contents of which are incorporated herein by reference.

### BACKGROUND OF THE INVENTION

1. Field of the Invention

This invention relates to phosphors and a display device, and more specifically relates to a thin display device such as a filed emission display (FED) including a screen constituted by electron-beam-induced phosphors.

2. Description of the Related Art

Up to now, a lot of energetic work has been devoted to development of such flat display panels as a plasma display (PDP) and a liquid crystal display (LCD). Those flat display panels are characterized by their flat and large screens. The screens may be enlarged to enable a display device to serve as a home theater. However, color television devices including cathode ray tubes (CRT) can assure crisp images, and are advantageous in this respect. Field emission displays (FEDs) are on the way as thin displays, and include not only fluorescent screens which feature CRTs but also electron guns striking electron beams onto the fluorescent screens. The FEDs seem promising since they can provide very crisp images compared with those offered by PDPs and LCDs.

The FED includes a screen on which red, green and blue phosphors are arranged in the shape of stripes or dots, and cathodes which are placed closely to the screen compared with those in a CRT. Each cathode includes a plurality of triangular electron sources as emitter elements. The triangular electron sources are provided respectively for the red, green and blue phosphors, and emit electrons in accordance with a potential difference between a gate electrode and the cathodes.

The emitted electrons are accelerated by an anode voltage (accelerating voltage) of the phosphors, and run against the phosphors, which will emit light beams.

With the foregoing FED, a distance between the cathodes and anodes of the phosphors is short compared with that of the CRT; the acceleration voltage (approximately 2 kV to 10 kV) of electron beams for promoting the light emission of the phosphors is lower than an acceleration voltage (25 kV to 35 kV) of the CRT; and current density of the FED is higher than that of the CRT. As a result, the phosphors of the FED tend to easily age because of collision of electrons compared with the CRT. Especially, with such a low energy cathode display as the FED having a low acceleration voltage, high density excitation energy has to be applied to the phosphors because luminance of the screen and energy efficiency degrade. Therefore, the phosphors of the FED should have sufficiently high light emitting efficiency, and be able to efficiently emit light beams when excited by the high current density and saturated. Sulfide phosphors (ZnS:Cu, ZnS:Ag) used for existing CRTs are promising candidates for the foregoing purpose.

The following two References (Reference 1 (B. L. Abrams, W. Roos, P. H. Holloway, and H. C. Swart, “Surface Science 451 (2000), p. 174-181) and Reference 2 (H. C. Swart, J. S. Sebastian, T. A. Trottier, S. L. Jones and P. H. Holloway, J. Vac. Sci. Technol. A14(3)(1996), p. 1967-1703) describe that ZnS is decomposed when it is excited in a low energy cathode display screen. This is because low energy electrons do not deeply break into phosphors, and tend to react on surfaces of the phosphors.

In order to overcome the foregoing problem, Reference 3 (JP-A 2000-096045 (KOKAI)) proposes to provide a coating which contains a kind of material selected from alkali-soil metal or phosphate composed of zinc or manganese. The measures improve luminance retentivity of the display screen which contains sulfide phosphors, slow down degradation of luminescence of emitted light beams, and promote light emission with high luminescence.

Further, Reference 3 proposes to apply such a phosphate compound as alkali-soil element, zinc or manganese onto the phosphors containing sulfur (S) in order to suppress degradation of the luminance of the phosphors with the lapse of time. However, Reference 3 does not refer to any specific compound. Further, Reference 3 has not disclosed a maximum amount of the phosphate compound in view of the life.

References 1 and 2 describe that H₂S and SO₂ gases are produced as expressed by the following formula when the low energy cathode display screen such as FED is excited.
2ZnS+3O₂→2ZnO+2SO₂↑
ZnS+H₂→Zn↑+H₂S↑

It is assumed here that an FED includes an electron source constituted by carbon nano tubes or that an SED includes a thin palladium oxide film. When illuminated by electron beams, phosphors may be decomposed by the reaction expressed by the foregoing formula, non-light-emitting layers will be formed, or luminescence of emitted light beams will be decreased due to coloring. Further, reduced emission efficiency of electrons will be caused because the electron source is contaminated by cracked gases of the phosphors. Therefore, it is very difficult for the FED or SED to maintain sufficient luminance during its operation for several thousand hours, compared to the CRTs.

The invention has been contemplated in order to overcome technical problems of the related art, and provides a phosphor which is applicable to an FED or SED and can suppress degradation of luminance due to variations of luminance of the phosphor and contamination of an electron source, and a display device including such a phosphor.

### SUMMARY OF THE INVENTION

According to a first aspect of the embodiment of the invention, there is provided a phosphor particle which includes: a phosphor containing zinc sulfide as a base material, and a coating layer applied on the phosphor and made of a magnesium phosphate expressed by Mg₃(PO₄)₂.

According to a second aspect of the embodiment of the invention, there is provided a display device which includes: an electron source mounted on a substrate, and a screen including a fluorescent film facing with the electron source. The fluorescent film is constituted by a phosphor containing zinc sulfide as a base material, and a coating layer applied on the phosphor and made of a magnesium phosphate expressed by Mg₃(PO₄)₂.

### BRIEF DESCRIPTION OF THE SEVERAL VIEWS OF THE DRAWINGS

FIG. 1A is a cross section of a display device according to a first embodiment of the invention;

FIG. 1B is a top plan view of the display device;

FIG. 2 is top plan view of a fluorescent film of the display device of FIG. 1;

FIG. 3 is a cross section of a phosphor particle constituting the fluorescent film of the display device of FIG. 1;

FIG. 4 is a graph showing electron emitting efficiency of the display device of FIG. 1 and electron emitting efficiency of a display device including an ordinary phosphor particle;

FIG. 5 is a cross section of a display device according to a second embodiment;

FIG. 6A is a top plan view of an electron source of the display device of FIG. 5;

FIG. 6B is a cross section of the electron source of the display device of FIG. 5;

FIG. 7 is a graph showing electron emitting efficiency of the display device of FIG. 5 and electron emitting efficiency of a display device including an ordinary phosphor particle;

FIG. 8 shows time-dependent variations of an electron emitting efficiency of the display device of FIG. 5;

FIG. 9 shows the relationship between an amount of magnesium or calcium actually used to coat the phosphor shown in FIG. 3 and an analyzed amount of magnesium or calcium stuck onto the phosphor;

FIG. 10 shows the relationship between an analyzed amount of Mg or Ca which seems to denote an amount of a coating for the phosphor, and an improvement factor of life of the screen in which the phosphor particle is included; and

FIG. 11 shows the relationship between an amount of sulfur dioxide (SO₂) generated when analyzing a heated gas of the phosphor particle of the display device in FIG. 5 and an improvement factor of life of the screen in which the phosphor particle is included.

### DETAILED DESCRIPTION OF THE INVENTION

The present invention will be described with reference to embodiments in which phosphors are applied in such a thin display device as an FED or an SED.

### FIRST EMBODIMENT OF DISPLAY DEVICE

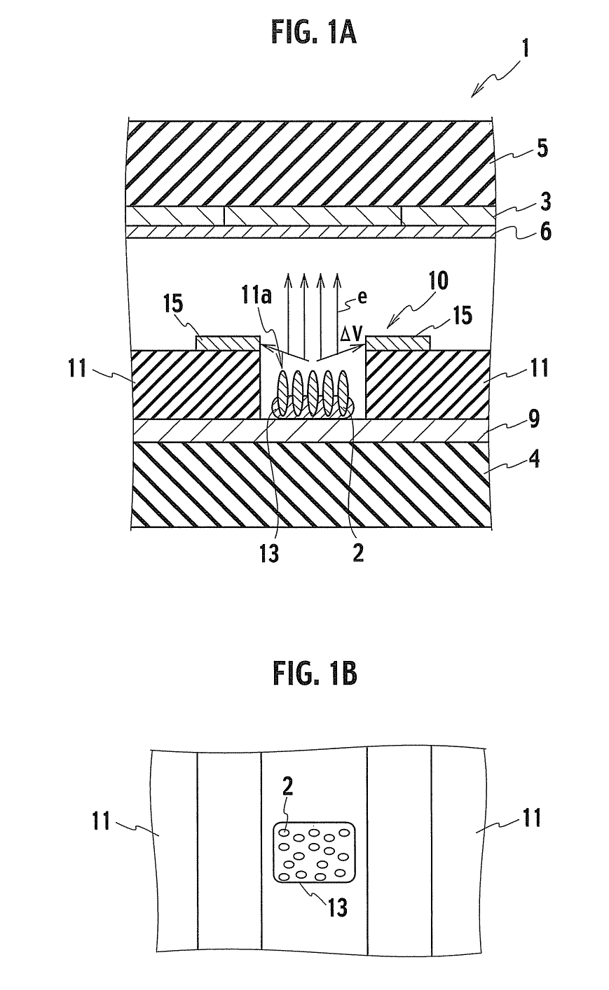

Referring to FIG. 1A, a display device 1 is an FED having rod-shaped carbon nano tubes 2 serving as an electron source, and a fluorescent film 3. The fluorescent film 3 is made of phosphor particles 20 which are made of phosphors 21 having zinc sulfate (ZnS) as a base material and covered by a magnesium phosphate expressed by Mg₃(PO₄)₂.

The carbon nano tubes 2 are very minute, and are several nm to several ten nm long. Therefore, they are enlarged in FIG. 1A and FIG. 1B.

The display device 1 further includes a substrate 4 on which the electron source is placed in order to emit electrons e, and a face plate 5 on which the fluorescent film 3 is placed and emits light when electrons e strike thereon. The substrate 4 and the face plate 5 face with each other. A clearance between the substrate 4 and the face plate 5 is kept airtight and vacuum by a side wall (not shown) extending around the substrate 4 and the face plate 5. The face plate 5 is made of glass, for instance, and carries the fluorescent film 3 on a side facing with the substrate 4. The fluorescent film 3 is provided with an aluminum film 6 serving as an anode.

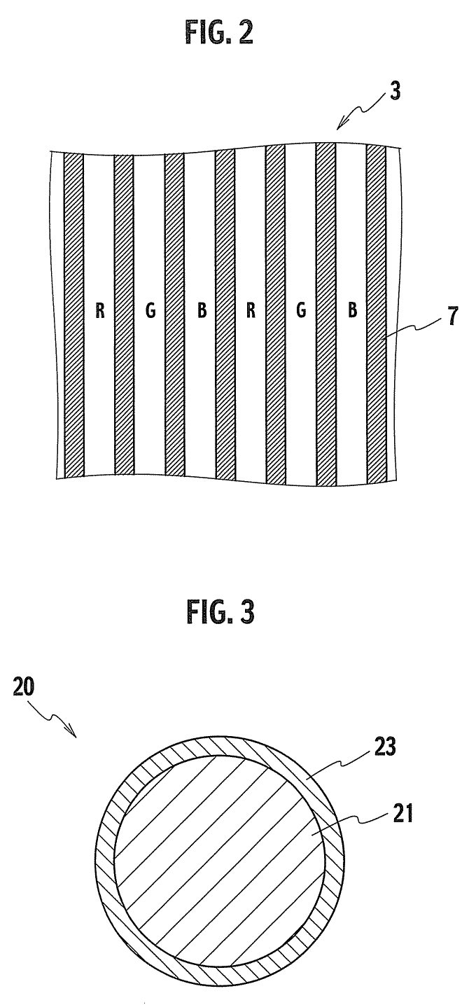

As shown in FIG. 2, the phosphors 21 of the phosphor particles 20, having the three primary colors R (red), G (green) and B (blue) are applied onto the fluorescent film 3 by slurry painting, exposure and development which are conducted sequentially. The phosphor particles 20 are arranged in the shape of stripes. The green and blue phosphors contain zinc sulfide (ZnS) as a base material, at least one selected from the group consisting of copper (Cu). gold (Au) and silver (Ag) as an activator, and at least one selected from the group consisting of aluminum (Al), chloride (Cl), bromine (Br) and iodine (I) as a co-activator. These phosphors are covered by an alkali soil phosphate compound. The red phosphors 21 are mainly made of yttrium oxysulfide (Y₂O₂S). Alternatively, the red, green and blue phosphor particles 20 may be arranged in the shape of dots. Further, the fluorescent film 3 may be sprayed or printed.

Black electric conductors 7 are placed between the red, green and blue stripes of the phosphor particles 20, and enable display colors to be precisely positioned even if electron beams may be out of alignment. Further, the black electric conductors 7 can prevent reflection of external light beams, reduction of display contrast, and over-charging of the fluorescent film 3 by electron beams. The black electric conductors 7 are mainly made of graphite, but may be of any material which can assure the forgoing performance.

Referring to FIG. 1A and FIG. 1B, a plurality of emitter elements 10 are provided for the red, green and blue phosphor particles 20 on one-to-one basis, and emit electrons. In these figures, only one emitter element 10 is shown. Each emitter element 10 includes a cathode 9 and an insulator 11 on the cathode 9. The insulator 11 has an opening 11a, via which a part of the cathode 9 is exposed toward the fluorescent film 3. For instance, the substrate 4 is preferably a glass substrate such as a quartz glass substrate or a blue plate glass substrate, or a ceramics glass substrate such as an alumina substrate. Alternatively the substrate 4 may be a glass substrate or a ceramics substrate on which an insulating film of silicon oxide (SiO₂) is placed.

The minute carbon nano tubes 2 are provided in the cathode 9 in the opening 11a. The carbon nano tubes 2 are dispersed on a conductive silver paste or the like. The conductive paste is dropped onto a surface of the cathode 9 exposed via the opening 11a or gaps of the insulator 11. The conductive paste is then cured, thereby making a conductive film 13. Therefore, the carbon nano tubes 2 form an electron emitting region on the substrate 4 facing with the fluorescent film 3.

The carbon nano tubes 2 stick out of the conductive film 13 where they are fixed. When a voltage Vf (a potential difference voltage ΔV) is applied between a control electrode 15 (gate electrode) and the protruding part of the carbon nano tubes 2, the electrons e will be released via outlets of the carbon nano tubes 2. The released electrons e are accelerated by an acceleration voltage Va applied between the cathode 9 and the anode (aluminum film 3) of the fluorescent film 3, and run into the fluorescent film 3, thereby making the fluorescent film 3 illuminant.

The following describe the phosphor particles 20 of the fluorescent film 3. Referring to FIG. 3, the phosphors 21 are excited by the electrons released from the electron source. The green and blue phosphors 21 contain zinc sulfide (ZnS) as the base material, at least one selected from the group consisting of copper (Cu), gold (Au) and silver (Ag) as the activator, and at least one selected from the group consisting of aluminum (Al), chloride (Cl), bromine (Br) and iodine (I) as the co-activator. These phosphors 21 are covered by a coating layer 23 made of an alkali soil phosphate compound. The red phosphors 21 is mainly made of a rare earth oxysulfide fluorescent substance such as yttrium sulfide oxide (Y₂O₂S).

The green and blue phosphors 21 covered by the coating layer 23 prevent the generation of degraded gases, and the degraded gases from sticking onto the electron source.

The coating layer 23 is made of such a phosphate compound as magnesium phosphate (Mg₃(PO₄)₂), suppresses degradation of the phosphors 21, and dries moisture in the atmosphere, which is effective in preventing the electron source (i.e., the carbon nano tubes 2 and the conductive film 13) from being contaminated by degraded phosphors 21, and in preventing the phosphors 21 from becoming less illuminant. Therefore, the phosphors 21 are very slow to degrade their light emitting efficiency, and the electron source can reliably release electrons for a long period of time.

Further, the coating layer 23 is very transparent, and reliably enables the phosphors 21 to substantially maintain their initial luminance. The phosphors 21 with the coating layer 23 can maintain excellent electron releasing performance, suppress degradation of the light emitting efficiency with the time lapse, and assure good luminance.

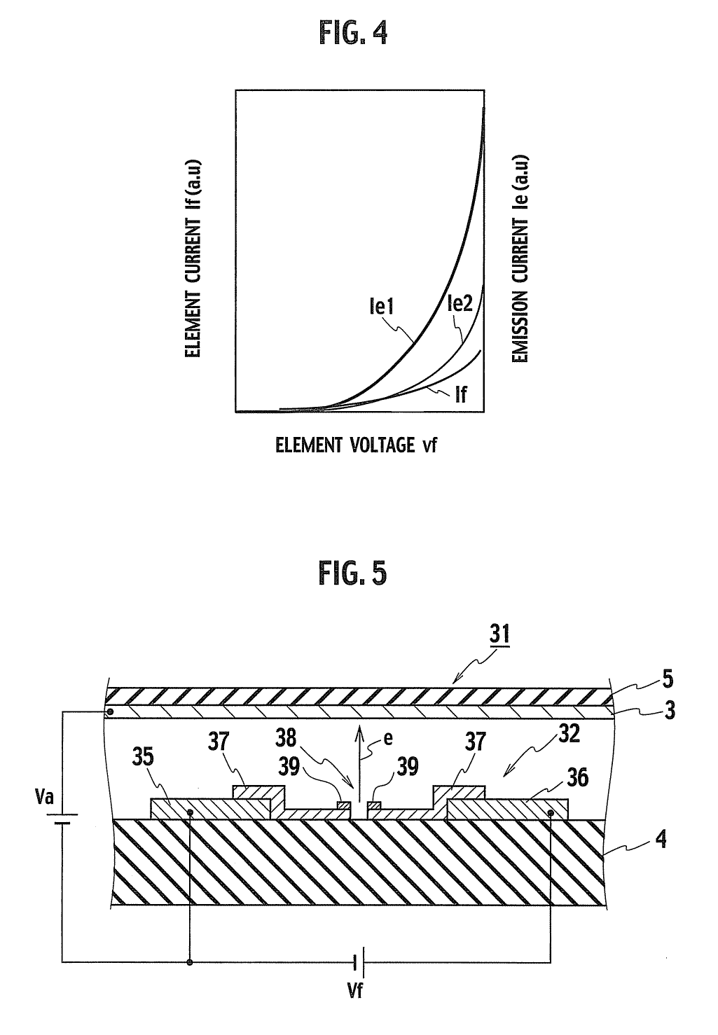

FIG. 4 is a graph showing electron emitting efficiency of the display device 1 of the first embodiment, and electron emitting efficiency of a display device including ordinary phosphor particles. The display device 1 includes a fluorescent film 23 which is made of ZnS:Cu, Au, Al phosphors (the phosphors include copper (Cu) and gold (Au) as the activator, and include aluminum (Al) as the co-activator) and the phosphors are coated with magnesium phosphate (Mg₃(PO₄)₂) in an amount of 0.05 weight %. The latter display device includes a fluorescent film which is made of ZnS:Cu, Au, Al phosphors and is coated with Zn silicate. FIG. 4 shows typical examples of (an emission current Ie) vs. (a voltage applied to elements VP, and (an electron current If) vs. (a voltage applied to elements Vf).

Referring to FIG. 4, an emission current Ie1 of the display device 1 having the phosphors 21 coated with magnesium phosphate is extensively improved in comparison with an emission current Ie2 of the display device having the phosphors coated with Zn silicate.

Further, the electron releasing efficiency Ie/If of the display device 1 remains as it is even after the lapse of 3,000 hours.

The display panels have been subject to accelerated electron beam life test by applying 10 kV radiation energy. The efficiency I/I0 of a screen of the display device includes a fluorescent film which is made of ZnS:Ag, Al and ZnS:Cu, Al phosphors and are coated with Zn silicate is remarkably reduced at an initial stage, and finally remains approximately 30% of an initial value. On the contrary, the luminance of the screen of the display device 1 of the first embodiment is slightly reduced, and remains approximately 80% of an initial value.

The coating layer 23 is fabricated as described later.

As described so far, the display device 1 has a number of electron sources compared with the display device of the related art. Specifically, the display device 1 is the FED, and includes the carbon nano tubes 2 (as the electron source) which are scattered in the conductive film 13. The display device of the related art is of FED in which the electron source is made of triangular pyramidal elements. This represents that degraded gases on the fluorescent film 3 tends to stick onto the electron sources.

In the first embodiment, the phosphors 21 of the fluorescent film 3 are covered by the phosphate compound of alkali soil group, thereby suppressing the generation of defraded gases caused by electron beams.

The foregoing measures keep the degraded gases, which are caused by the phosphors 21, from sticking onto the carbon nano tubes 2. This is effective in reliably maintaining the electron releasing performance and preventing degradation of the emission efficiency of the phosphors.

Further, moisture is considered to be one of factors which contaminate the electron sources. Phosphate oxide (P₂O₅) is known to dehydrate acidic moisture, and a phosphate compound has a similar attribute. Therefore, the coating layer 23 itself adsorbs moisture, and protects the electron sources against contamination.

### SECOND EMBODIMENT OF DISPLAY DEVICE

Referring to FIG. 5, a display device 31 of a second embodiment includes a film-shaped emitter element 32, and a screen. The emitter element 32 functions as an electron source which releases electron beams. The screen includes phosphors which face with an electron beam releasing area of the emitter element 32, are mainly made of zinc sulfide excited by electron beams from the electron source, and are covered by a fluorescent film of a magnesium phosphate (Mg₃(PO₄)₂). The display device 31 also includes the same components as those of the display device 1 of the first embodiment. They are not described here.

With the display device 31, a substrate 4 carrying the emitter element 32 faces with a face plate 5 which includes a fluorescent film 3. The fluorescent film 3 emits light beams when electrons from the emitter elements 32 strike thereon. A clearance between the substrate 4 and the face plate 5 is made airtight and vacuum by a side wall (not shown) surrounding them.

The face plate 5 is a glass substrate, for instance. The fluorescent film 3 is placed on the face plate 5 on a side thereof facing with the substrate 4.

As shown in FIG. 3, the phosphors 21 of the phosphor particles 20, having the three primary colors R (red), G (green) and B (blue) are applied onto the fluorescent film 3, and are arranged in the shape of stripes. The green and blue phosphors 21 contain zinc sulfide (ZnS) as a base material, at least one selected from the group consisting of copper (Cu), gold (Au) and silver (Ag) as an activator, and at least one selected from the group consisting of aluminum (Al), chloride (Cl), bromine (Br) and iodine (I) as a co-activator. These phosphors are covered by an alkali soil phosphate compound. The red phosphors are mainly made of yttrium oxysulfide (Y₂O₂S). Alternatively, the red, green and blue phosphor particles may be arranged in the shape of dots. Black electric conductors 7 are placed between the red, green and blue stripes of the phosphor particles 20.

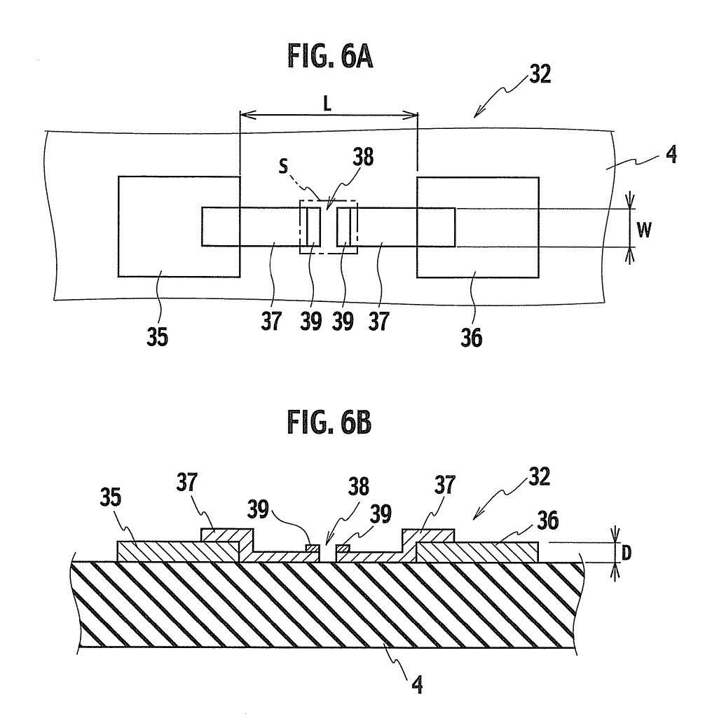

The emitter elements 32 are provided for the red, green and blue phosphor particles on the one-to-one basis. Only one emitter element 32 is shown in FIG. 6A and FIG. 6B. Each emitter element 32 is constituted by element electrodes 35 and 36 placed on the substrate 4; a thin conductive film 37 extending over the substrate 4 and the element electrodes 35 and 36; an electron releasing part 38; and a thin film 39 extending at the opposite sides of the electron releasing part 38. The electron releasing part 38 is made by conductive forming, is in the shape of a crack, and functions as electron releasing region S on the substrate 4. The thin film 39 is prepared by conductive activation.

The substrate 4 may be a glass substrate such as a quartz glass substrate and a blue plate glass substrate; a ceramics substrate such as an alumina substrate; or any of the foregoing substrates which is coated by an insulating layer made of silicon oxide (SiO₂).

The element electrodes 35 and 36 face with each other on the substrate 4, and are made of such conductive materials metals as nickel (Ni), chrome (Cr), gold (Au), molybdenum (Mo), tungsten (W), platinum (Pt), titanium (Ti), copper (Cu), palladium (Pd), or silver (Ag). Further, the element electrodes 35 and 36 may be made of an alloy of the foregoing metals, such metal oxide as In₂O₃—SnO₂ and so on, or a polysilicon semiconductor and so on. The element electrodes 35 and 36 are prepared by the vacuum evaporation or photolithography process, and are patterned by the etching process. Any other printing techniques are also usable in combination. These element electrodes 35 and 36 are shaped in accordance with a shape of the display device 31.

A clearance L between the element electrodes 35 and 36 is preferably several ten nm to several hundred μm. In the second embodiment, the clearance L is several μm to several ten am which is preferable to the display device 31. A thickness D between the element electrodes 35 and 36 are several ten nm to several μm.

The thin conductive film 37 is made of fine particles whose diameter is preferably several hundred pico-meters (pm) to several hundred nm. In the second embodiment, the diameter is several nm to 20 nm.

A thickness of the thin conductive film 37 is determined in accordance with requirements necessary for an optimum electric connection with the element electrodes 35 and 36, requirements for reliable conductive forming to be described later, electric resistance of the thin conductive film 37, and so on. Specifically, the thin conductive film 37 is preferably several hundred pm to several hundred nm. In the second embodiment, the thin conductive film 37 is 1 nm to 50 nm thick.

The thin conductive film 37 may be made of such metals as palladium (Pd), platinum (Pt), ruthenium (Ru), silver (Ag), gold (Au), titanium (Ti), indium (In), copper (Cu), chrome (Cr), iron (Fe), zinc (Zn), tin (Sn), tantalum (Ta), tungsten (W), and lead (Pb); oxides such as PdO, SnO₂, In₂O₃, PbO, and Sb₂O₃: borides such as HfB₂, ZrB₂, LaB₆, CeB₆, YB₄, and GdB₄; carbides such as TiC, ZrC, HfC, TaC, Sic and WC; nitrides such as TiN, ZrN and HfN; semiconductors such as silicon (Si) and germanium (Ge); or carbon.

Sheet resistance of the thin conductive film 37 made of fine particles is designed to be 10³ Ω/cm² to 10⁷ Ω/cm².

The thin conductive film 37 overlaps with the element electrodes 35 and 36 in order to assure good electrical connection between them. As shown in FIG. 6B, the element electrodes 35 and 36 are placed on the substrate 4, and the thin conductive film 37 is placed on the element electrodes 35 and 36. Alternatively, the thin conductive film 37 is placed on the substrate 4, and the element electrodes 35 and 36 are placed on the thin conductive film 37, if necessary.

The electron releasing part 38 is positioned at a part of the thin conductive film 37, is in the shape of a crack, and has high electric resistance compared with that of the thin conductive film 37. The thin conductive film 37 is subject to the conductive forming in order to make the electron releasing part 38. For this purpose, electricity is conducted to the thin conductive film 37 in order to partially break, deform and change the quality of the thin conductive film 37, thereby making the electron releasing part 38. Sometimes, fine particles having a diameter of several hundred pm to several ten nm are filled in the electron releasing part 38. In FIG. 5, FIG. 6A and FIG. 6B, the electron releasing part 38 is schematically depicted since it is very difficult to precisely show the shape and position of thereof.

A thin film 39 made of carbon or a carbon compound extends over and around the electron releasing part 38. The thin film 39 is made by the conductive forming, and conductive activation. For the conductive activation, voltage pulses are periodically applied in a vacuum in order to deposit carbon or carbon compounds originating from organic compounds which are present in the vacuum. The deposited materials are single crystal graphite, poly-crystal graphite or amorphous carbon, or mixture of the foregoing materials, and are equal to or less than 50 nm thick, preferably equal to or less than 30 nm thick.

The thin film 39 is schematically depicted in FIG. 5, FIG. 6A and FIG. 6B since it is very difficult to show the shape and position thereof.

When a voltage (Vf) of over 10 volts is applied between the element electrodes 35 and 36 of the emitter element 32 of the display device 31, electrons will be released from one end of the electron releasing part 38 in the thin conductive film 37. Some electrons scatter at the other end of the electron releasing part 38, are accelerated by an anode voltage Va of approximately 10 voltage, and strike onto the phosphor particles 20 of the fluorescent film 3. Therefore, the phosphors 21 of the phosphor particles 20 become luminous.

The phosphor particles of the fluorescent film 3 will be described hereinafter. The phosphor particles of this embodiment are similar to the phosphor particles 20 in the first embodiment shown in FIG. 3. The green and blue phosphors contain zinc sulfide (ZnS) as a base material, at least one selected from the group consisting of copper (Cu). gold (Au) and silver (Ag) as an activator, and at least one selected from the group consisting of aluminum (Al), chloride (Cl), bromine (Br) and iodine (I) as a co-activator. These phosphors are covered by a coating layer 23 made of an alkali soil phosphate compound. The red phosphor is mainly made of rare earth oxysulfide fluorescent substance such as europium activating yttrium oxysulfide (Y₂O₂S:Eu).

Even when the foregoing phosphors covered by the coating layer 23 are exposed to high-density electron beams, it is possible to suppress the generation of degraded gases, and to prevent the degraded gases from sticking onto the electron releasing region S (shown in FIG. 6A).

The coating layer 23 is made of magnesium phosphate (Mg₃(PO₄)₂) as the alkali soil phosphate. Magnesium phosphate suppresses not only decomposition of the phosphors but also contamination of the electron releasing region S due to the decomposition of the phosphors. Therefore, this measure is effective in assuring reliable and sufficient release of electrons by the electron source.

Further, the coating layer 23 is very transparent, and sufficiently assures the initial luminance of the phosphor 21. The phosphors 21 with the coating layer 23 can maintain excellent electron releasing performance, suppress degradation of the light emitting efficiency with the time lapse, and assure good luminance of the electron source.

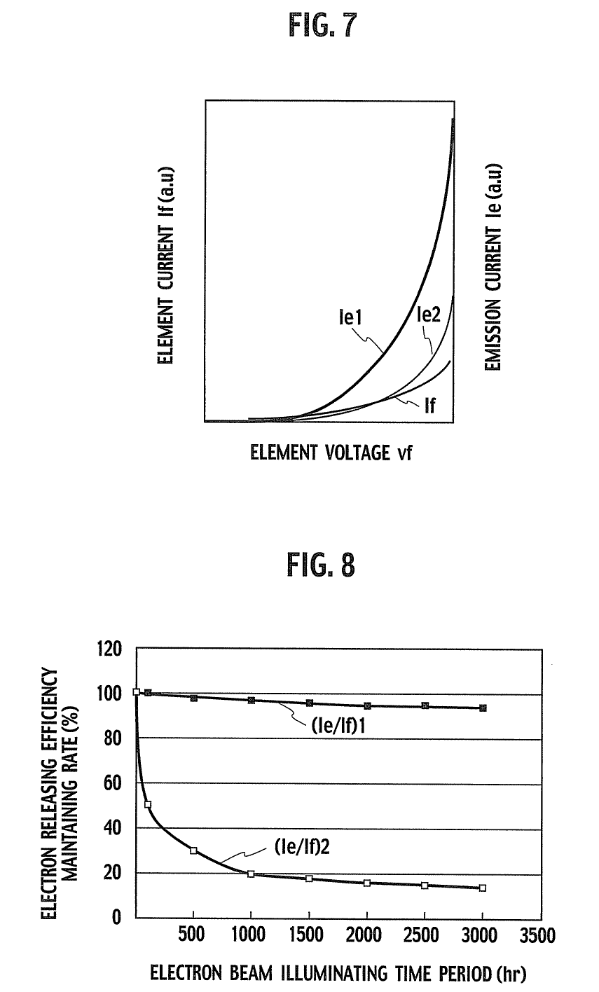

FIG. 7 is a graph showing electron emitting efficiency of the display device 31, and electron emitting efficiency of a display device including ordinary phosphor particles. The display device 31 includes a fluorescent film 23 which is made of ZnS:Cu, Au, Al phosphors (the phosphors include copper (Cu) and gold (Au) as the activator, and include aluminum (Al) as the co-activator) and the phosphors are coated with magnesium phosphate (Mg₃(PO₄)₂) in an amount of 0.05 weight %. The latter display device includes a fluorescent film which is made of ZnS:Cu, Au, Al phosphors and is coated with Zn silicate. FIG. 7 shows typical examples of (an emission current Ie) vs. (a voltage applied to elements VF), and (an electron current If) vs. (a voltage applied to elements VF).

Referring to FIG. 7, the emission current Ie1 of the display device 31 having the phosphors 21 coated with magnesium phosphate is extensively improved in comparison with the emission current Ie2 of the display device having the phosphors coated with Zn silicate.

Further, the electron releasing efficiency Ie/If (=1.0%) of the display device 31 remains as it is even after the lapse of 3,500 hours.

The display panels have been subject to accelerated electron beam life test by applying 10 kV radiation energy. The efficiency I/I0 (where I0 denotes the initial luminance, and I denotes luminance after a lapse of a certain time period) of a screen of the display device includes a fluorescent film which is made of ZnS:Ag, Al and ZnS:Cu, Al phosphors and are coated with Zn silicate is remarkably reduced at an initial stage, and finally remains approximately 20% of an initial value. On the contrary, the luminance of the screen of the display device 31 of the second embodiment is slightly reduced, and remains approximately 80% of an initial value.

As can be seen in FIG. 8, the electron releasing efficiency (Ie/If) reduces with the lapse of time hr. The electron releasing efficiency of the display device 31 remains high after the lapse of 3,000 hours compared with that of the display device including the phosphors coated with Zn silicate.

The coating layer 23 will be made as described later.

With the foregoing display device 31, the distance between the electron releasing part 38 and the fluorescent film 3 is short, and a space for housing vacuum capsules is narrow. Therefore, few produced gases tend to adhere to a side wall compared with those in a CRT, and are difficult to be extricated. Further, the emitter element 32 has a large electron releasing region S compared with the FED having triangular pyramidal elements. This represents that degraded gases on the fluorescent film 3 tend to stick onto the electron releasing region S.

With the display device 31, the phosphors 21 of the fluorescent film 3 are covered by the alkali soil phosphate compound, which is effective in suppressing the generation of degraded gases due to electron beams.

Further, degraded gases of the phosphors 21 are prevented from sticking onto the electron releasing region S of the emitter element 32, which is effective in preventing degradation of the electron releasing performance.

Still further, moisture is considered to be one of factors which contaminate the electron source. Phosphate oxide (P₂O₅) is known to dehydrate acidic moisture, and a phosphate compound has a similar attribute. Therefore, the coating layer 23 itself absorbs moisture, and protects the electron source against contamination.

(Coating Layer for Phosphors)

The following describe the coating layer 23 for the phosphors 21 in the first and second embodiments.

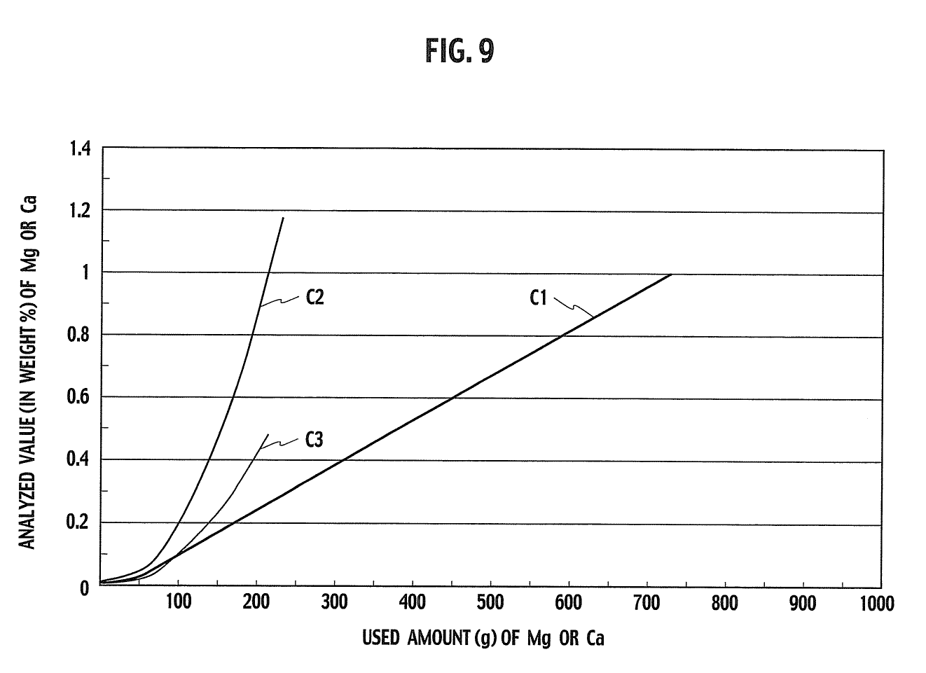

The phosphors 21 with the coating layer 23 are made using magnesium phosphate, magnesium metaphosphate or calcium metaphosphate. FIG. 9 shows the relationship between an amount of a surface treating material, i.e., magnesium (Mg) or calcium (Ca), to be used, an amount of Mg or Ca contained in the coating layer 23 produced on the phosphors 21 (the latter amount being called “coating amount” (weight %)), and being derived through a chemical analysis). The coating amount represents weight % of Mg and Ca in the phosphors 21 and the coating layer 23. The chemical analysis is conducted using the induced-combined plasma emission spectrometry (ICPS).

Referring to FIG. 9, the characteristic curve C1 represents the relationship between the coating amount and an amount of Mg or Ca used for the magnesium phosphate treatment. The characteristic curve C2 represents the coating amount and an amount of Mg or Ca used for the magnesium metaphosphate treatment. Further, the characteristic curve C3 represents the coating amount and an amount of Mg or Ca used for the calcium metaphosphate treatment. In the following examples and comparison examples, coating layers 23 are made of Mg or Ca in various coating amounts. The graph in FIG. 9 is useful for deriving the coating amounts in the actual coating layers 23.

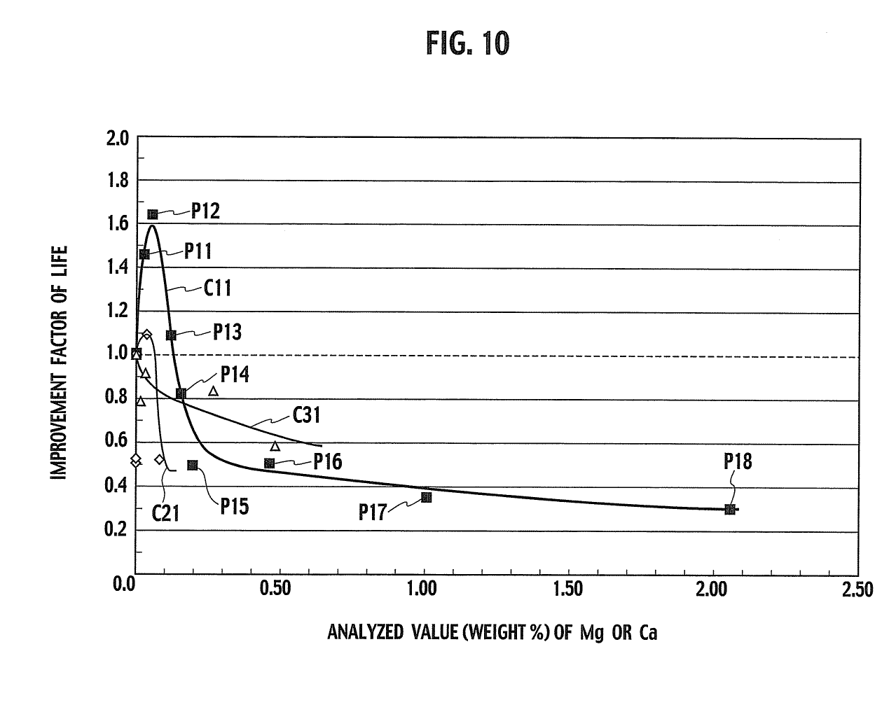

FIG. 10 shows the relationship between an improvement factor of life of the fluorescent film 3 (display panel) of the display device 31 of the second embodiment and the coating amounts of the coating layers 23 which undergo the foregoing treatments. Refer to FIG. 5 and FIG. 6 with respect to the display device 31. The “improvement factor of life” is derived by dividing a time period (for the luminance of a panel including coated phosphors to reach 80% of an initial value) by a time period (for the luminance of a panel without the coating to reach 80 of an initial value).

In FIG. 10, the characteristic curve C11 shows the relationship between the coating amount and the improvement factor of life when the magnesium phosphate treatment is applied in some examples and comparison examples. Plot P11 represents the relationship between the improvement factor of life and the coating amount of the phosphors 21 with the coating layer 23 in the first and fourth examples. Plot P12 represents the relationship between the improvement factor of life and the coating amount of the phosphors 21 with the coating layer 23 in the second and fifth examples. Plot P13 represents the relationship between the improvement factor of life and the coating amount of the phosphors 21 with the coating layer 23 in third and sixth embodiments. Plot P14 represents the relationship between the improvement factor of life and the coating amount of the phosphors 21 with the coating layer 23 in first and sixth comparison examples. Plot P15 represents the relationship between the improvement factor of life and the coating amount of the phosphors 21 with the coating layer 23 in second and seventh comparison examples. Plot P16 represents the relationship between the improvement factor of life and the coating amount of the phosphors 21 with the coating layer 23 in third and eighth comparison examples. Plot P17 represents the relationship between the improvement factor of life and the coating amount of the phosphors 21 with the coating layer 23 in fourth and ninth comparison examples. Plot P18 represents the relationship between the improvement factor of life and the coating amount of the phosphors 21 with the coating layer 23 in fifth and tenth comparison examples.

Further, in FIG. 10, the characteristic curve C21 represents the relationship between the coating amount and the improvement factor of life when the magnesium metaphosphate treatment is applied in eleventh, twelfth, thirteenth and fourteenth comparison examples. The characteristic curve C31 represents the relationship between the coating amount and the improvement factor of life when the calcium metaphosphate treatment is applied in fifteenth, sixteenth, seventeenth and eighteenth comparison examples.

As can be seen in FIG. 10, the more the coating amount of magnesium phosphate, the longer the display panel life, but the display panel life becomes short when the coating amount exceeds a certain value. Therefore, 0.01 weight % to 0.15 weight % of magnesium is preferably applied to the coating layer 23 as the amount of magnesium phosphate. The display panel life seems improved when the foregoing amount of magnesium is applied. In order to stably manufacture the phosphor particles in which the coating layer 23 is reliably formed, an amount of magnesium phosphate for the coating layer 23 is preferably equal to or more than 0.03 weight percent in terms of Mg. In the embodiments of the present invention, the coating amount is designed to be 0.03 weight % to 0.15 weight %.

The coating layer 23 has an approximately 4 nm thickness, which can be analyzed using a transmission electron microscope (TEM). In order to confirm elements composing the surface of the phosphor particles, the Auger electron spectroscopy is applied. It is possible to check whether or not the coating layer 23 completely covers the phosphors. The coating layer 23 is hydrophilic, and has an affinity to an ordinary coating layer. The coating layer 23 is applicable as a base for an additional further coating layer, and can improve powder characteristics or color saturation of the phosphor particles 20. The coating layer 23 itself does not show any sign of aging. An electron irradiation test shows that the display device can improve its electron releasing efficiency and reliability, which means that the display device can lengthen its life because of the coating layer 23 as a whole. Phosphor particles are prepared by coating methods in the first to twenty-first comparison examples to be described later. Display device including those phosphor particles have shortened the life length compared with display device without any coating layer. The following phenomena are observed because the fluorescent substances of the phosphors are decomposed: a number of non-light-emitting layers; color development; and reduced luminance of the phosphors.

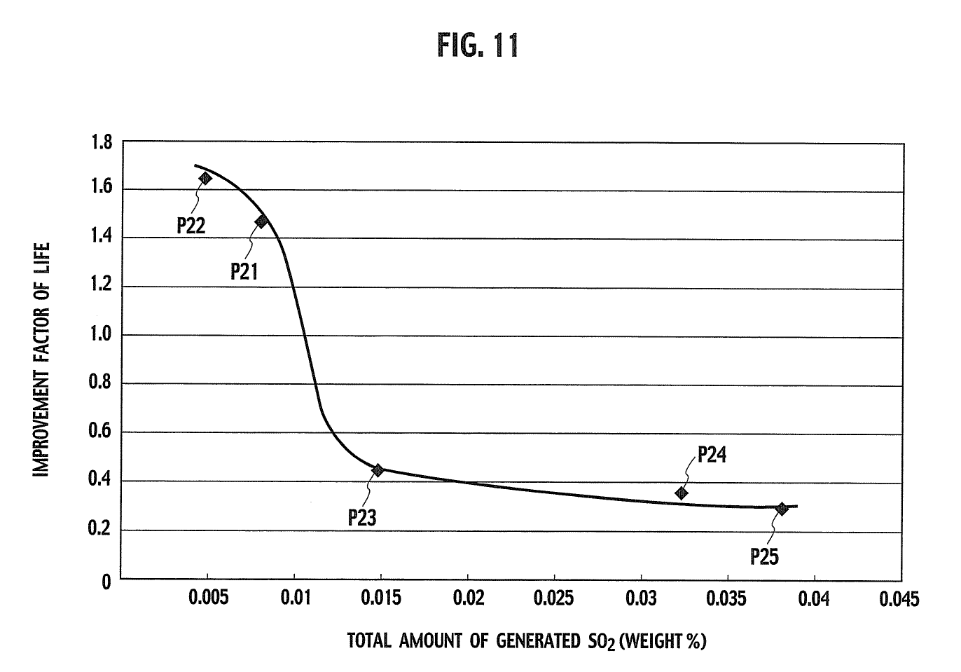

FIG. 11 shows how the improvement factor of life varies with an amount of released sulfur dioxide (SO₂) during a heated gas analysis. The “Heated gas analysis” represents to analyze gases generated by heating the phosphor particles in a helium atmosphere at a room temperature (30° C.) to 1000° C. at a speed of 20° C./min. The generated gas, i.e., SO₂, is expressed by weight %. The weight % is derived by dividing the amount of SO₂ by the amount of the analyzed phosphor particles.

Plot 21 in FIG. 11 represents the relationship between an amount of SO₂ released from the phosphors 21 covered with the coating layer 23 (prepared by the magnesium phosphate treatment in the seventh embodiment) and an improvement factor of life of the display panel including the foregoing phosphors 21. Plot 22 represents the relationship between an amount of SO₂ released from the phosphors 21 covered with the coating layer 23 (prepared by the magnesium phosphate treatment in the eighth example) and an improvement factor of life of the display panel including the foregoing phosphors 21. Plot 23 represents the relationship between an amount of SO₂ released from the phosphors 21 covered with the coating layer 23 (prepared by the magnesium phosphate treatment in the nineteenth comparison example) and an improvement factor of life of the display panel including the foregoing phosphors 21. Plot 24 represents the relationship between an amount of SO₂ released from the phosphors 21 covered with the coating layer 23 (prepared by the magnesium phosphate treatment in the twentieth comparison example) and an improvement factor of life of the display panel including the foregoing phosphors 21. Plot 25 represents the relationship between an amount of SO₂ released from the phosphors 21 covered with the coating layer 23 (prepared by the magnesium phosphate treatment in the twenty-first comparison example) and an improvement factor of life of the display panel including the foregoing phosphors 21.

As can be seen in FIG. 11, when the phosphors 21 are sufficiently covered by the coating layer 23 and when the amount of discharged SO₂ is equal to or less than 1×10⁻² weight %, the improvement factor of life is equal to or larger than 1.0 compared with that of the phosphors 21 without any coating. This represents that the life of the display panel is improved.

### FIRST EXAMPLE

Method of Making Magnesium Phosphate (Mg₃(PO₄)₂) Coating Layer

Disodium dihydrogenphosphate in the amount of 4.5 g is put into 5000 mL water, is agitated for one hour, and is made to pass through a glass filter, in order to make a base solution, in which 2000 g ZnS; Ag, Al phosphors are suspended. The base solution is agitated for twenty minutes. A sodium hydrate solution in the amount of 3 N is put into the base solution, so that pH of the base solution is equal to 10. At the same time, MgCl₂.6H₂O in the amount of 46 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, a reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four times using purified water, are rinsed using acetone, and are dried at a temperature of 140° C.

The phosphors 21 with the coating layer 23 (i.e., the phosphor particles 20) of the first example are used in the display panel. The improvement factor of life of the display panel is shown by Plot 11 in FIG. 10, and is equal to or larger than 1.0. This means that the coated phosphors 21 improve the improvement factor of life compared with phosphor without the coating layer 23.

### SECOND EXAMPLE

Method of Making Magnesium Phosphate (Mg₃(PO₄)₂) Coating Layer

In this example, the amount of disodium dihydrogenphosphate and the amount of MgCl₂.6H₂O are different from the amount of those in the first example.

Disodium dihydrogenphosphate in the amount of 9 g is put into 5000 mL water, is agitated for one hour, and is made to pass through a glass filter, in order to make a base solution, in which 2000 g ZnS; Ag, Al phosphors are suspended. The base solution is agitated for twenty minutes. A sodium hydrate solution in the amount of 3 N is put into the base solution, so that pH of the base solution is equal to 10. At the same time, MgCl₂.6H₂O in the amount of 92 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to pH 10. A magnesium chloride solution is added into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four times using purified water, are rinsed using acetone, and are dried at the temperature of 140° C.

The phosphors 21 with the coating layer 23 (i.e., the phosphor particles 20) of the second example are used in the display panel. The improvement factor of life of the display panel is shown by Plot 12 in FIG. 10, and is equal to or larger than 1.0. This means that the coated phosphor 21 improve the improvement factor of life compared with the phosphor without the coating layer 23.

### THIRD EXAMPLE

Method of Making Magnesium Phosphate (Mg₃(PO₄)₂) Coating Layer

In this example, the amount of disodium dihydrogenphosphate and the amount of MgCl₂.6H₂O are different from the amount of those in the first example.

Disodium dihydrogenphosphate in the amount of 12.1 g is put into 5000 mL water, is agitated for one hour, and is made to pass through a glass filter in order to make a base solution, in which 2000 g ZnS; Ag, Al phosphors are suspended. The base solution is agitated for twenty minutes. A sodium hydrate solution in the amount of 3 N is put into the base solution, so that pH of the base solution is equal to 10. At the same time, MgCl₂.6H₂O in the amount of 123 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C.

The phosphors 21 with the coating layer 23 (i.e., the phosphor particles 20) of the third example are used in the display panel. The improvement factor of life of the display panel is shown by Plot 13 in FIG. 10, and is equal to or larger than 1.0. This means that the coated phosphors 21 improve the improvement factor of life compared with phosphor without the coating layer 23.

### FOURTH EXAMPLE)

Method of Making Magnesium Phosphate (Mg₃(PO₄)₂) Coating Layer

In this example, ZnS:Cu, Al phosphors are used as substitute for ZnS:Ag, Al phosphors in the first example.

Disodium dihydrogenphosphate in the amount of 4.5 g is put into 5000 mL water, is agitated for one hour, and is made to pass through a glass filter, in order to make a base solution, in which 2000 g ZnS; Cu, Al phosphors are suspended. The base solution is agitated for twenty minutes. A sodium hydrate solution in the amount of 3 N is put into the base solution, so that pH of the base solution is equal to 10. At the same time, MgCl₂.6H₂O in the amount of 46 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four times using purified water, are rinsed using acetone, and are dried at the temperature of 140° C.

The phosphors 21 with the coating layer 23 (i.e., the phosphor particles 20) of the forth example are used in the display panel. The improvement factor of life of the display panel is shown by Plot 11 in FIG. 10, and is equal to or larger than 1.0. This means that the coated phosphors 21 improve the improvement factor of life compared with the phosphor without the coating layer 23.

### FIFTH EXAMPLE

Method of Making Magnesium Phosphate (Mg₃(PO₄)₂) Coating Layer

In this example, ZnS:Cu, Al phosphors are used as substitute for ZnS:Ag, Al phosphors in the second example.

Disodium dihydrogenphosphate in the amount of 9 g is put into 5000 mL water, is agitated for one hour, and is made to pass through a glass filter, in order to make a base solution, in which 2000 g ZnS; Cu, Al phosphors are suspended. The base solution is agitated for twenty minutes. A sodium hydrate solution in the amount of 3 N is put into the base solution, so that pH of the base solution becomes equal to 10. At the same time, MgCl₂.6H₂O in the amount of 92 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is added into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four times using purified water, are rinsed using acetone, and are dried at a temperature of 140° C.

The phosphors 21 with the coating layer 23 (i.e., phosphors 20) of the fifth example are used in the display panel. The improvement factor of life of the display panel is shown by Plot 12 in FIG. 10, and is equal to or larger than 1.0. This means that the coated phosphors 21 improve the improvement factor of life compared with the phosphors without the coating layer 23.

### SIXTH EXAMPLE

Method of Making Magnesium Phosphate (Mg₃(PO₄)₂) Coating Layer

In this example, ZnS:Cu, Al phosphors are used as substitute for ZnS:Ag, Al phosphors in the third example.

Disodium dihydrogenphosphate in the amount of 12.1 g is put into 5000 mL water, is agitated for one hour, and is made to pass through a glass filter, in order to make a base solution, in which 2000 g ZnS; Cu, Al phosphors are suspended. The base solution is agitated for twenty minutes. A sodium hydrate solution in the amount of 3 N is put into the base solution, so that pH of the base solution becomes equal to 10. At the same time, MgCl₂.6H₂O in the amount of 123 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to pH 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C.

The phosphors 21 with the coating layer 23 (i.e., the phosphor particles 20) of the sixth example are used in the display panel. The improvement factor of life of the display panel is shown by Plot 13 in FIG. 10, and is equal to or larger than 1.0. This means that the coated phosphors 21 improve the improvement factor of life compared with phosphor without the coating layer 23.

### SEVENTH EXAMPLE

Method of Making Magnesium Phosphate (Mg₃(PO₄)₂) Coating Layer

In this example, the phosphor particles prepared by the method of the fourth example is subject to the heated gas analysis. Disodium dihydrogenphosphate in the amount of 4.5 g is put into 500 mL water, is agitated for one hour, and is made to pass through a glass filter, in order to make a base solution, in which 2000 g ZnS; Cu, Al phosphors are suspended. The base solution is agitated for 20 minutes. A sodium hydrate solution in the amount of 3 N is put into the base solution, so that pH of the base solution is equal to 10. At the same time, MgCl₂.6H₂O in the amount of 46 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four times using purified water, are rinsed using acetone, and are dried at the temperature of 140° C.

An amount of SO₂ released from the heat-gas-analyzed phosphor particles is 0.8×10⁻² weight %. The improvement factor of life of the display panel is shown by Plot 21 in FIG. 11, and is equal to or larger than 1.0. This means that the coated phosphors 21 improve the improvement factor of life compared with phosphor without the coating layer 23.

The heated gas analysis is conducted in a helium atmosphere, and the phosphor particles are heated from 30° C. to 1,000° C. at a rate of 20° C./min.

### EIGHTH EXAMPLE

Method of Making Magnesium Phosphate (Mg₃(PO₄)₂) Coating Layer

In this example, the phosphors are prepared by the method of the fifth example, and are subject to the heated gas analysis. Disodium dihydrogenphosphate in the amount of 9 g is put into 5000 mL water, is agitated for one hour, and is made to pass through a glass filter, in order to make a base solution, in which 2000 g ZnS; Cu, Al phosphors are suspended. The base solution is agitated for twenty minutes. A sodium hydrate solution in the amount of 3 N is put into the base solution, so that pH of the base solution becomes equal to 10. At the same time, MgCl₂.6H₂O in the amount of 92 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is added into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C.

An amount of SO₂ released from the heat-gas-analyzed phosphor particles 21 is 0.8×10⁻² weight %. The improvement factor of life of the display panel is shown by Plot 22 in FIG. 11, and is equal to or larger than 1.0. This means that the coated phosphors 21 improve the improvement factor of life compared with phosphor without the coating layer 23.

The heated gas analysis is conducted in a helium atmosphere, and the phosphor particles are heated from 30° C. to 1,000° C. at 20° C./min.

### FIRST COMPARISON EXAMPLE

Method of Making Magnesium Phosphate (Mg₃(PO₄)₂) Coating Layer

Disodium dihydrogenphosphate in the amount of 14.9 g is put into 5000 mL water, is agitated for one hour, and is passed through a glass filter in order to make a base solution, in which 2000 g ZnS; Ag, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 153 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the first comparison example are used in the display panel. The improvement factor of life of the display panel is shown by Plot 14 in FIG. 10, and is less than 1.0. This means that the coated phosphors degrade the improvement factor of life compared with phosphors without the coating layer.

### SECOND COMPARISON EXAMPLE

Method of Making Magnesium Phosphate (Mg₃(PO₄)₂) Coating Layer

In this comparison example, the amount of disodium dihydrogenphosphate and the amount of MgCl₂.6H₂O are different from the amount of those in the first comparison example. Disodium dihydrogenphosphate in the amount of 18 g is put into 5000 mL water, is agitated for one hour, and is made to pass through a glass filter in order to make a base solution, in which 2000 g ZnS; Ag, Al phosphors are suspended. The base solution is agitated for twenty minutes. A sodium hydrate solution in the amount of 3 N is put into the base solution, so that pH of the base solution is equal to 10. At the same time, MgCl₂.6H₂O in the amount of 184 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the solution, are rinsed four times using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the second comparison example are used in the display panel. The improvement factor of life of the display panel is shown by Plot 15 in FIG. 10, and is less than 1.0. This means that the coated phosphors degrade the improvement factor of life compared with phosphors without the coating layer.

### THIRD COMPARISON EXAMPLE

Method of Making Magnesium Phosphate (Mg₃(PO₄)₂) Coating Layer

In this comparison example, the amount of disodium dihydrogenphosphate and the amount of MgCl₂.6H₂O are different from the amount of those in the first comparison example.

Disodium dihydrogenphosphate in the amount of 36 g is put into 5000 mL water, is agitated for one hour, and is made to pass through a glass filter in order to make a base solution, in which 2000 g ZnS; Ag, Al phosphors are suspended. The base solution is agitated for twenty minutes. A sodium hydrate solution in the amount of 3 N is put into the base solution, so that pH of the base solution becomes equal to 10. At the same time, MgCl₂.6H₂O in the amount of 368 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the third comparison example are used in the display panel. The improvement factor of life of the display panel is shown by Plot 16 in FIG. 10, and is less than 1.0. This means that the coated phosphors degrade the improvement factor of life compared with phosphors without the coating layer.

### FOURTH COMPARISON EXAMPLE

Method of Making Magnesium Phosphate (Mg₃(PO₄)₂) Coating Layer

In this comparison example, the amount of disodium dihydrogenphosphate and the amount of MgCl₂.6H₂O are different from the amount of those in the first comparison example.

Disodium dihydrogenphosphate in the amount of 72 g is put into 5000 mL water, is agitated for one hour, and is made to pass through a glass filter in order to make a base solution, in which 2000 g ZnS; Ag, Al phosphors are suspended. The base solution is agitated for twenty minutes. A sodium hydrate solution in the amount of 3 N is put into the base solution, so that pH of the base solution becomes equal to 10. At the same time, MgCl₂.6H₂O in the amount of 736 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the forth comparison example are used in the display panel. The improvement factor of life of the display panel is shown by Plot 17 in FIG. 10, and is less than 1.0. This means that the coated phosphors degrade the improvement factor of life compared with phosphors without the coating layer.

### FIFTH COMPARISON EXAMPLE

Method of Making Magnesium Phosphate (Mg₃(PO₄)₂) Coating Layer

In this comparison example, the amount of disodium dihydrogenphosphate and the amount of MgCl₂.6H₂O are different from the amount of those in the first comparison example.

Disodium dihydrogenphosphate in the amount of 144 g is put into 5000 mL water, is agitated for one hour, and is made to pass through a glass filter in order to make a base solution, in which 2000 g ZnS; Ag, Al phosphors are suspended. The base solution is agitated for twenty minutes. A sodium hydrate solution in the amount of 3 N is put into the base solution, so that pH of the base solution becomes equal to 10. At the same time, MgCl₂.6H₂O in the amount of 1472 g is dissolved into 4800 mL water (which is called a MgCl₂.6H₂O solution), which is put into the base solution. The base solution and the MgCl₂.6H₂O solution are heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the fifth comparison example are used in the display panel. The improvement factor of life of the display panel is shown by Plot 18 in FIG. 10, and is less than 1.0. This means that the coated phosphors degrade the improvement factor of life compared with phosphors without the coating layer.

### SIXTH COMPARISON EXAMPLE

Method of Making Magnesium Phosphate (Mg₃(PO₄)₂) Coating Layer

In this comparison example, ZnS:Cu, Al phosphors are used as substitute for ZnS:Ag, Al phosphors in the first comparison example.

Disodium dihydrogenphosphate in the amount of 14.9 g is put into 5000 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 153 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the sixth comparison example are used in the display panel. The improvement factor of life of the display panel is shown by Plot 14 in FIG. 10, and is less than 1.0. This means that the coated phosphors degrade the improvement factor of life compared with phosphors without the coating layer.

### SEVENTH COMPARISON EXAMPLE

Method of Making Magnesium Phosphate (Mg₃(PO₄)₂) Coating Layer

In this comparison example, ZnS:Cu, Al phosphors are used as substitute for ZnS:Ag, Al phosphors in the second comparison example.

Disodium dihydrogenphosphate in the amount of 18 g is put into 5000 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 184 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the seventh comparison example are used in the display panel. The improvement factor of life of the display panel is shown by Plot 15 in FIG. 10, and is less than 1.0. This means that the coated phosphors degrade the improvement factor of life compared with phosphors without the coating layer.

### EIGHTH COMPARISON EXAMPLE

Method of Making Magnesium Phosphate (Mg₃(PO₄)₂) Coating Layer

In this comparison example, ZnS:Cu, Al phosphors are used as substitute for ZnS:Ag, Al phosphors in the third comparison example.

Disodium dihydrogenphosphate in the amount of 36 g is put into 5000 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 368 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the eighth comparison example are used in the display panel. The improvement factor of life of the display panel is shown by Plot 16 in FIG. 10, and is less than 1.0. This means that the coated phosphors degrade the improvement factor of life compared with phosphors without the coating layer.

### NINTH COMPARISON EXAMPLE

Method of Making Magnesium Phosphate (Mg₃(PO₄)₂) Coating Layer

In this comparison example, ZnS:Cu, Al phosphors are used as substitute for ZnS:Ag, Al phosphors in the forth comparison example.

Disodium dihydrogenphosphate in the amount of 72 g is put into 500 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 736 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the phosphor particles) of the ninth comparison example are used in the display panel. The improvement factor of life of the display panel is shown by Plot 17 in FIG. 10, and is less than 1.0. This means that the coated phosphors degrade the improvement factor of life compared with phosphors without the coating layer.

### TENTH COMPARISON EXAMPLE

Method of Making Magnesium Phosphate (MG₃(PO₄)₂) Coating Layer

In this comparison example, ZnS:Cu, Al phosphors are used as substitute for ZnS:Ag, Al phosphors in the fifth comparison example.

Disodium dihydrogenphosphate in the amount of 144 g is put into 5000 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 1472 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C. The following phenomena are observed because the phosphor particles are decomposed: a number of non-light-emitting layers, color development, and reduced luminance of the phosphors.

The phosphors with the coating layer (i.e., the fluorescent particles) of the tenth comparison example are used in the display panel. The improvement factor of life of the display panel is shown by Plot 18 in FIG. 10, and is less than 1.0. This means that the coated phosphors degrade the improvement factor of life compared with phosphors without the coating layer.

### ELEVENTH COMPARISON EXAMPLE

Method of Making Magnesium Metaphosphate (Mg(PO₃)₂) Coating Layer

In this comparison example, the materials of a coating layer are different from that in the foregoing example.

Polyphosphoric acid in the amount of 16.8 g is added in 500 mL water, is agitated for one hour, and is passed through a glass filter in order to make a base solution, in which 2000 g ZnS; Cu, Al phosphors are suspended. The base solution is agitated for twenty minutes. At the same time, Mg(NO₃)₂.6H₂O in the amount of 38.4 g is dissolved into 4800 mL water, and one-mole aqueous ammonia in the amount of 200 mL is prepared, both of which are put into the base solution. The base solution is designed to demonstrate pH 6.5 to pH 7.5. The base solution is agitated for two hours. The coated phosphors are settled out, and a clear supernatant liquid is removed using a centrifugal separator. The phosphors are centrifugally separated from the base solution, are rinsed three times using purified water, are rinsed using acetone, and are dried at the temperature of 140° C. The following phenomena are observed because the phosphor particles are decomposed: a number of non-light-emitting layers, color development, and reduced luminance of the phosphors. The phosphors with the coating layer (i.e., the phosphor particles) of the eleventh comparison example are used in the display panel. The improvement factor of life of the display panel is shown by the characteristic curve C21 in FIG. 10. The coated phosphors degrade the improvement factor of life compared with phosphors without the coating layer.

### TWELFTH COMPARISON EXAMPLE

Method of Making Magnesium Metaphosphate (Mg(PO₃)₂) Coating Layer

In this comparison example, the amount of polyphosphoric acid and the amount of Mg(NO₃)₂.6H₂O are different from the amount of those in the eleventh comparison example.

Polyphosphoric acid in the amount of 33.6 g is added in 500 mL water, is agitated for one hour, and is passed through a glass filter in order to make a base solution, in which 2000 g ZnS; Cu, Al phosphors are suspended. The base solution is agitated for twenty minutes. At the same time, Mg(NO₃)₂.6H₂O in the amount of 77 g is dissolved into 4800 mL water, and one-mole aqueous ammonia in the amount of 200 mL is prepared, both of which are put into the base solution. The base solution is designed to demonstrate pH 6.5 to pH 7.5. The base solution is agitated for two hours. The coated phosphors are settled out, and a clear supernatant liquid is removed using a centrifugal separator. The coated phosphors are centrifugally separated from the base solution, are rinsed three times using purified water, are rinsed using acetone, and are dried at the temperature of 140° C. The following phenomena are observed because the phosphor particles are decomposed: a number of non-light-emitting layers, color development, and reduced luminance of the phosphors. The phosphors with the coating layer (i.e., the phosphor particles) of the twelfth comparison example are used in the display panel. The improvement factor of life of the display panel is shown by the characteristic curve C21 in FIG. 10. The coated phosphors degrade the improvement factor of life compared with phosphors without the coating layer.

### THIRTEENTH COMPARISON EXAMPLE

Method of Making Magnesium Metaphosphate (Mg(PO₃)₂) Coating Layer

In this comparison example, the amount of polyphosphoric acid and the amount of Mg(NO₃)₂.6H₂O are different from the amount of those in the eleventh comparison example.

Polyphosphoric acid in the amount of 67.2 g is added in 500 mL water, is agitated for one hour, and is passed through a glass filter in order to make a base solution, in which 2000 g ZnS; Cu, Al phosphors are suspended. The base solution is agitated for twenty minutes. At the same time, Mg(NO₃)₂.6H₂O in the amount of 154 g is dissolved into 4800 mL water, and one-mole aqueous ammonia in the amount of 200 mL is prepared, both of which are put into the base solution. The base solution is designed to demonstrate pH 6.5 to pH 7.5. The base solution is agitated for two hours. The coated phosphors are settled out, and a clear supernatant liquid is removed using a centrifugal separator. The coated phosphors are centrifugally separated from the base solution, are rinsed three times using purified water, are rinsed using acetone, and are dried at the temperature of 140° C. The following phenomena are observed because the phosphor particles are decomposed: a number of non-light-emitting layers, color development, and reduced luminance of the phosphors. The phosphors with the coating layer (i.e., the phosphor particles) of the thirteenth comparison example are used in the display panel. The improvement factor of life of the display panel is shown by the characteristic curve C21 in FIG. 10. The coated phosphors degrade the improvement factor of life compared with phosphors without the coating layer.

### FOURTEENTH COMPARISON EXAMPLE

Method of Making Magnesium Metaphosphate (Mg(PO₃)₂) Coating Layer

In this comparison example, the amount of polyphosphoric acid and the amount of Mg(NO₃)₂.6H₂O are different from the amount of those in the eleventh comparison example.

Polyphosphoric acid in the amount of 100.8 g is added in 5000 mL water, is agitated for one hour, and is passed through a glass filter in order to make a base solution, in which 2000 g ZnS; Cu, Al phosphors are suspended. The base solution is agitated for twenty minutes. At the same time, Mg(NO₃)₂.6H₂O in the amount of 231 g is dissolved into 4800 mL water, and one-mole aqueous ammonia in the amount of 200 mL is prepared, both of which are put into the base solution. The base solution is designed to demonstrate pH 6.5 to pH 7.5. The base solution is agitated for two hours. The coated phosphors are settled out, and a clear supernatant liquid is removed using a centrifugal separator. The coated phosphors are centrifugally separated from the base solution, are rinsed three times using purified water, are rinsed using acetone, and are dried at the temperature of 140° C. The following phenomena are observed because the phosphor particles are decomposed: a number of non-light-emitting layers, color development, and reduced luminance of the phosphors. The phosphors with the coating layer (i.e., the phosphor particles) of the fourteenth comparison example are used in the display panel. The improvement factor of life of the display panel is shown by the characteristic curve C21 in FIG. 10. The coated phosphors degrade the improvement factor of life compared with phosphors without the coating layer.

### FIFTEENTH COMPARISON EXAMPLE

Method of Making Calsium Metaphosphate (Ca(PO₃)₂) Coating Layer

In this comparison example, the materials of a coating layer are different from that in the foregoing example.

Hexametaphosphate in the amount of 19.2 g is mixed in a one-mole aqueous ammonia in the amount of 200 mL in order to make a base solution. Specifically, the aqueous ammonia is added whenever pH of becomes below 6, so that the base solution with fully dissolved hexametaphosphate demonstrates approximately pH 7. Thereafter, water is put into the base solution so that the base solution becomes 2500 mL. ZnS; Cu, Al phosphors in the amount of 1000 g are suspended in the base solution. The base solution is agitated for twenty minutes. At the same time, Ca(NO₃)₂.4H₂O in the amount of 35.4 g is dissolved into 2400 mL water, which is dropped into the base solution. A lithium hydroxide solution is put into the base solution, so that the base solution demonstrates pH 6.9 to 7.5. The base solution is agitated for one hour. The coated phosphors are settled out, and a clear supernatant liquid is removed. The coated phosphors are rinsed several times using a water-acetone mixture in a ratio of 1 to 1, are rinsed by acetone, and are dried at the temperature of 100° C. The following phenomena are observed because the phosphor particles are decomposed: a number of non-light-emitting layers, color development, and reduced luminance of the phosphors. The phosphors with the coating layer (i.e., the phosphor particles) of the fifteenth comparison example are used in the display panel. The improvement factor of life of the display panel is shown by the characteristic curve C31 in FIG. 10. The coated phosphors degrade the improvement factor of life compared with phosphors without the coating layer.

### SIXTEENTH COMPARISON EXAMPLE

Method of Making Calsium Metaphosphate (Ca(PO₃)₂) Coating Layer

In this comparison example, the amount of hexametaphosphate and the amount of Ca(NO₃)₂.4H₂O are different from the amount of those in the fifteenth comparison example.

Hexametaphosphate in the amount of 38.5 g is mixed in a one-mole aqueous ammonia in the amount of 200 mL in order to make a base solution. Specifically, the aqueous ammonia is added whenever pH of becomes below 6, so that the base solution with fully dissolved hexametaphosphate demonstrates approximately pH 7. Thereafter, water is put into the base solution so that the base solution becomes 2500 mL. ZnS; Cu, Al phosphors in the amount of 1000 g are suspended in the base solution. The base solution is agitated for twenty minutes. At the same time, Ca(NO₃)₂.4H₂O in the amount of 70.8 g is dissolved into 2400 mL water, which is dropped into the base solution. A lithium hydroxide solution is put into the base solution, so that the base solution demonstrates pH 6.9 to 7.5. The base solution is agitated for one hour. The coated phosphors are settled out, and a clear supernatant liquid is removed. The coated phosphors are rinsed several times using a water-acetone mixture in a ratio of 1 to 1, are rinsed by acetone, and are dried at the temperature of 100° C. The following phenomena are observed because the phosphor particles are decomposed: a number of non-light-emitting layers, color development, and reduced luminance of the phosphors. The phosphors with the coating layer (i.e., the phosphor particles) of the sixteenth comparison example are used in the display panel. The improvement factor of life of the display panel is shown by the characteristic curve C31 in FIG. 10. The coated phosphors degrade the improvement factor of life compared with phosphors without the coating layer.

### SEVENTEENTH COMPARISON EXAMPLE

Method of Making Calsium Metaphosphate (Ca(PO₃)₂) Coating Layer

In this comparison example, the amount of hexametaphosphate and the amount of Ca(NO₃)₂.4H₂O are different from the amount of those in the fifteenth comparison example.

Hexametaphosphate in the amount of 77 g is mixed in a one-mole aqueous ammonia in the amount of 200 mL in order to make a base solution. Specifically, the aqueous ammonia is added whenever pH of becomes below 6, so that the base solution with fully dissolved hexametaphosphate demonstrates approximately pH 7. Thereafter, water is put into the base solution so that the base solution becomes 2500 mL. ZnS; Cu, Al phosphors in the amount of 1000 g are suspended in the base solution. The base solution is agitated for twenty minutes. At the same time, Ca(NO₃)₂.4H₂O in the amount of 141.6 g is dissolved into 2400 mL water, which is dropped into the base solution. A lithium hydroxide solution is put into the base solution, so that the base solution demonstrates pH 6.9 to 7.5. The base solution is agitated for one hour. The coated phosphors are settled out, and a clear supernatant liquid is removed. The coated phosphors are rinsed several times using a water-acetone mixture in a ratio of 1 to 1, are rinsed by acetone, and are dried at the temperature of 100° C. The following phenomena are observed because the phosphor particles are decomposed: a number of non-light-emitting layers, color development, and reduced luminance of the phosphors. The phosphors with the coating layer (i.e., the phosphor particles) of the sixteenth comparison example are used in the display panel. The improvement factor of life of the display panel is shown by the characteristic curve C31 in FIG. 10. The coated phosphors degrade the improvement factor of life compared with phosphors without the coating layer.

### EIGHTEENTH COMPARISON EXAMPLE

Method of Making Calsium Metaphosphate (Ca(PO₃)₂) Coating Layer

In this comparison example, the amount of hexametaphosphate and the amount of Ca(NO₃)₂.4H₂O are different from the amount of those in the fifteenth comparison example.

Hexametaphosphate in the amount of 115.6 g is mixed in a one-mole aqueous ammonia in the amount of 200 mL in order to make a base solution. Specifically, the aqueous ammonia is added whenever pH of becomes below 6, so that the base solution with fully dissolved hexametaphosphate demonstrates approximately pH 7. Thereafter, water is put into the base solution so that the base solution becomes 2500 mL. ZnS; Cu, Al phosphors in the amount of 1000 g are suspended in the base solution. The base solution is agitated for twenty minutes. At the same time, Ca(NO₃)₂.4H₂O in the amount of 212.4 g is dissolved into 2400 mL water, which is dropped into the base solution. A lithium hydroxide solution is put into the base solution, so that the base solution demonstrates pH 6.9 to 7.5. The base solution is agitated for one hour. The phosphors substances are settled out, and a clear supernatant liquid is removed. The coated phosphors are rinsed several times using a water-acetone mixture in a ratio of 1 to 1, are rinsed by acetone, and are dried at the temperature of 100° C. The following phenomena are observed because the phosphor particles are decomposed: a number of non-light-emitting layers, color development, and reduced luminance of the phosphors. The phosphors with the coating layer (i.e., the phosphor particles) of the sixteenth comparison example are used in the display panel. The improvement factor of life of the display panel is shown by the characteristic curve C31 in FIG. 10. The coated phosphors degrade the improvement factor of life compared with phosphors without the coating layer.

### NINETEENTH COMPARISON EXAMPLE

Method of Making Magnesium Phosphate (Mg₃(PO₄)₂) Coating Layer

In this comparison example, the phosphor particles prepared by the method of the seventh comparison example is subject to the heated gas analysis.

Disodium dihydrogenphosphate in the amount of 18 g is put into 5000 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 184 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C.

An amount of SO₂ released from the coated phosphors (phosphor particles) after the heated gas analysis is 1.5×10⁻² (weight %) as shown by Plot 23 in FIG. 11.

The heat gas analysis is conducted in a helium atmosphere which is heated from a room temperature (30° C.) to 1000° C. at a rate of 20° C./min.

The following phenomena are observed because the phosphor particles are decomposed: a number of non-light-emitting layers, color development, and reduced luminance of the phosphors. The phosphors with the coating layer (i.e., the phosphor particles) of the nineteenth comparison example are used in the display panel. The coated phosphors degrade the improvement factor of life compared with phosphors without the coating layer.

### TWENTIETH COMPARISON EXAMPLE

Method of Making Magnesium Phosphate (Mg₃(PO₄)₂) Coating Layer

In this comparison example, the phosphor particles prepared by the method of the ninth comparison example is subject to the heated gas analysis.

Disodium dihydrogenphosphate in the amount of 72 g is put into 500 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 736 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C.

An amount of SO₂ released from the coated phosphors (phosphor particles) after the heated gas analysis is 3.2×10⁻² (weight %) as shown by Plot 24 in FIG. 11.

The heat gas analysis is conducted in a helium atmosphere which is heated from a room temperature (30° C.) to 1000° C. at a rate of 20° C./min.

The following phenomena are observed because the phosphor particles are decomposed: a number of non-light-emitting layers, color development, and reduced luminance of the phosphors. The phosphors with the coating layer (i.e., the phosphor particles) of the twentieth comparison example are used in the display panel. The coated phosphors degrade the improvement factor of life compared with phosphors without the coating layer.

### TWENTYFIRST COMPARISON EXAMPLE

Method of Making Magnesium Phosphate (Mg₃(PO₄)₂) Coating Layer

In this comparison example, the phosphor particles prepared by the method of the tenth comparison example is subject to the heated gas analysis.

Disodium dihydrogenphosphate in the amount of 144 g is put into 5000 mL water, is agitated for one hour, and is passed through a glass filter in order to make a base solution, in which 2000 g ZnS; Cu, Al phosphors are suspended. The base solution is agitated for twenty minutes. A sodium hydrate solution in the amount of 3 N is added into the base solution, so that pH of the solution becomes equal to 10. At the same time, MgCl₂.6H₂O in the amount of 1472 g is dissolved into 4800 mL water (which is called a MgCl₂.6H₂O solution), which is put into the base solution. The base solution and the MgCl₂.6H₂O solution are is heated or stored in ice so that it becomes 20° C. to 30° C. During the application of MgCl₂.6H₂O, the reaction temperature for adding sodium phosphate is made to be 20° C. to 30° C. The base solution is designed to demonstrate pH 9 to 10. A magnesium chloride solution is put into the base solution in which the phosphors are suspended, and is agitated for two hours. The coated phosphors are settled out, and a clear supernatant liquid is removed using a centrifugal separator. The coated phosphors are centrifugally separated from the base solution, are rinsed four time using purified water, are rinsed using acetone, and are dried at the temperature of 140° C.

An amount of SO₂ released from the coated phosphors (phosphor particles) after the heated gas analysis is 3.8×10⁻² (weight %) as shown by Plot 25 in FIG. 11.

The heat gas analysis is conducted in a helium atmosphere which is heated from a room temperature (30° C.) to 1000° C. at a rate of 20° C./min.

The following phenomena are observed because the phosphor particles are decomposed: a number of non-light-emitting layers, color development, and reduced luminance of the phosphors. The phosphors with the coating layer (i.e., the phosphor particles) of the twentyfirst comparison example are used in the display panel. The coated phosphors degrade the improvement factor of life compared with phosphors without the coating layer.

### OTHER EXAMPLES

The coating layers 23 made of magnesium phosphate are formed by the methods described in the first to eighth example. Alternatively, the coating layers 23 may be produced using the reaction of water-soluble phosphate, ammonium phosphate or water-soluble magnesium salt.

What is claimed is:

1. A phosphor particle comprising:
a phosphor containing zinc sulfide as a base material; and
a coating layer applied on the phosphor and made of a magnesium phosphate expressed by Mg₃(PO₄)₂.

2. The phosphor particle defined in claim 1, wherein the magnesium phosphate is applied in a range of 0.01 weight % to 0.15 weight % when calculated in terms of a magnesium element.

3. The phosphor particle defined in claim 1, wherein a quantity of sulfur dioxide (SO₂) is equal to or less than 1×10⁻² weight % when the phosphor particle is heated from 30° C. to 1000° C. at a rate of 20° C./minute.

4. The phosphor particle defined in claim 2, wherein a quantity of sulfur dioxide (SO₂) is equal to or less than 1×10⁻² weight % when the phosphor particle is heated from 30° C. to 1000° C. at a rate of 20° C./minute.

5. A display device comprising:
an electron source mounted on a substrate; and
a screen including a fluorescent film facing with the electron source, the fluorescent film being constituted by a phosphor containing zinc sulfide as a base material; and a coating layer applied on the phosphor and made of a magnesium phosphate expressed by Mg₃(PO₄)₂.

6. The display device defined in claim 5, wherein the magnesium phosphate is applied in a range of 0.01 weight % to 0.15 weight % when calculated in terms of a magnesium element.

7. The display device defined in claim 5, wherein a quantity of sulfur dioxide (SO₂) is equal to or less than 1×10⁻² weight % when the phosphor particle is heated from 30° C. to 1000° C. at a rate of 20° C./minute.

8. The display device defined in claim 6, wherein a quantity of sulfur dioxide (SO₂) is equal to or less than 1×10⁻² weight % when the phosphor particle is heated from 30° C. to 1000° C. at a rate of 20° C./minute.
